(19) United States
(12) Patent Application Publication
(10) Pub. No.: US 2001/0026248 A1
(43) Pub. Date: Oct. 4, 2001

(54) Method and apparatus for providing visual display security

(76) Inventors: Andrew Goren, Cranbury, NJ (US); Arshad Masood, Cranbury, NJ (US)

Correspondence Address: LERNER, DAVID, LITTENBERG,, KRUMHOLZ & MENTLIK, 600 SOUTH AVENUE WEST, WESTFIELD, NJ, 07090, US

(21) Appl. No.: 09/726,794

(22) Filed: Nov. 30, 2000

Related U.S. Application Data
(60) Provisional application No. 60/167,990, filed on Nov. 30, 1999.

(51) Int. Cl. G09C 1/00; G09G 5/00; G03F 5/00

(52) U.S. Cl. 345/7; 283/17; 359/893

(57) ABSTRACT

A system for providing visual display security on a general-purpose computer, the general-purpose computer capable of running an operating system and an application, the operating program system and application program presenting a user interface in the form of display windows, includes a display window having a default display characteristic and a computer security program operating on the general purpose computer. The computer security program altering the default display characteristic to a modified display characteristic, the modified display characteristic rendering the display window unreadable to a human eye. The system also includes an optical filter matched to the modified display characteristic so that the display window becomes readable when viewed through the optical filter.

### CROSS-REFERENCE TO RELATED APPLICATIONS

The present application claims benefit of U.S. Provisional Application No. 60/167,990 filed Nov. 30, 1999, the disclosure of which of which is hereby incorporated by reference herein.

### BACKGROUND OF THE INVENTION

The present invention relates generally to apparatus and methods for providing security for a visual display of a computer monitor. More particularly, the present invention is directed to apparatus and methods for obscuring one or more windows in a computer display by colorizing or “painting” those windows with a pattern of a particular color and providing the user an optical color filter specifically matched to the pattern so that the obscured window contents may be viewed normally by the user.

Display devices such as video monitors for computer systems are commonly used in many areas of work and every day life. For example, laptop computers are frequently used by individuals when traveling on buses and planes. As a result, it is not unusual for such devices to display information in public that is confidential and private, and thus is intended only for viewing by the individual user using the display device. Unfortunately, particularly when traveling in public, it may not be possible to limit the number of people in the vicinity of the display screen. In such cases, the information displayed on the screen may be viewed by unauthorized personnel.

There have been a number of efforts directed to filtering or limiting access to information displayed on a video monitor. For example, U.S. Pat. No. 5,115,345 to Hobson et al. discloses a visor formed from a blank of material capable of being oriented so that a portion projects from a top wall of a video terminal and side portions extend from sidewalls, thereby increasing the privacy of the material displayed on the screen. U.S. Pat. No. 4,444,465 to Giulie et al. discloses an adjustable shield that fits over a display screen. The shield has three telescoping pieces that may be adjusted to limit the visibility of the screen. U.S. Pat. No. 4,812,709 to Dudasik discloses a privacy screen for a color display screen that shields displayed images from observers to the sides of the screen. In addition, 3M provides a notebook privacy filter for a laptop computer. The privacy filter is placed over the video screen of a computer. The privacy filter allows an individual directly in front of the screen to view the document while preventing individuals to the side from reading the material on the screen. The screen appears blank to individuals sitting to the sides of the screen.

In spite of the above improvements in the art, there remains a need for improved systems for filtering information presented on video monitors.

### SUMMARY OF THE INVENTION

In accordance with certain preferred embodiments of the present invention, a system for providing visual display security on a general-purpose computer, the general-purpose computer being capable of running an operating system and an application program, the operating system and application program presenting a user interface in the form of display windows, includes a display window having a default display characteristic and a computer security program operating on the general purpose computer. The computer security program preferably alters the default display characteristic to a modified display characteristic, the modified display characteristic rendering the display window unreadable to a human eye. The system also preferably includes an optical filter matched to the modified display characteristic so that the display window becomes readable when viewed through the optical filter. The modified display may include a random dot stereo gram, a stretching algorithm applied to the display window, a blurring algorithm applied to the display window, an optical pattern superimposed on the display window wherein the optical pattern includes a color matched to the optical filter, and a displayed image shape.

In certain preferred embodiments, the optical filter may include a lens such as one or more lenses on a pair of glasses. In other preferred embodiments, the optical filter may include an at least partially transparent film placed over the display window. In still other preferred embodiments, the optical filter may be a screen placed on the display window. In some embodiments, the system may include a password protection module for disabling and enabling the visual display security system. The system may also include a tuner for matching the modified display characteristic to the optical filter being used to view the display.

In still other preferred embodiments of the present invention, a system for providing visual display security on a general-purpose computer, the general-purpose computer being capable of running an operating system in an application program, the operating system and application program presenting a user interface in the form of display windows, includes a display window having a default display characteristic and a computer security program operating on the general purpose computer. The computer security program preferably alters the default display characteristic to a modified display characteristic, the computer security program overlaying a pattern on the display window, the pattern operatively associated with said modified display characteristic, the pattern rendering the display window unreadable. The system also preferably includes an optical filter operatively associated with the pattern so that the display window becomes readable when viewed through the optical filter. The default display characteristic may be a default font color, and the modified display characteristic may be a modified font color, whereby the pattern is a colorized pattern and the optical filter is a colored filter, the modified font color being matched to the optical filter so as to permit the modified font color to be visible as perceived through the optical filter when the colorized pattern is overlayed on the display window.

In still other preferred embodiments of the present invention, a method for providing visual display security on a general-purpose computer, the general-purpose computer being capable of running an operating system and an application program, the operating system and application program presenting a user interface in the form of display windows, includes displaying a window having a default display characteristic and altering the default display characteristic to a modified display characteristic using a computer security program operating on the general purpose computer, the alteration rendering the display window unreadable to a human eye. The method also preferably includes filtering the display window with an optical filter matched to the modified display characteristics so that the display window becomes readable when viewed through the optical filter. The step of altering the default display characteristic may include obtaining an application program handle, intercepting events generated by the program handle, and reapplying continuously the modified display characteristic in response to the intercepted events. The method may also include tuning the modified display characteristic to match the optical filter. In still other embodiments, the method may include creating a list including a plurality of active display windows in selecting one of the plurality of active display windows in which to alter the default display characteristic.

In yet further preferred embodiments of the present invention, a method for providing visual display security on a general-purpose computer, the general-purpose computer being capable of running an operating system and an application program, the operating system and application program presenting a user interface in the form of display windows, includes displaying a window having a default display characteristic, and altering the default display characteristic to a modified display characteristic using a computer security program operating on the general purpose computer. The method also preferably includes matching a pattern to the modified display characteristic, overlying the pattern on the display window, the pattern rendering the display window unreadable, and filtering the display window with an optical filter matched to the pattern so that the display window becomes readable when viewed through the optical filter. The method may also include creating a list including a plurality of active display windows in selecting one of the plurality of active display windows for which to overlay the pattern.

In further preferred embodiments, a computer-readable medium for storing a set of instructions for providing visual display security on a general-purpose computer, the general-purpose computer being capable of running an operating system and an application program, the operating system and application program presenting a user interface in the form of display windows, the instructions comprising instructions for causing the computer to display a window having a default display characteristic and alter the default display characteristic to a modified display characteristic using a computer security program operating on the general-purpose computer. The alteration rendering the display window unreadable and the modified display characteristic in the display window being filtered with an optical filter matched to the modified display characteristic so that the display window becomes readable when viewed through the optical filter.

In yet further preferred embodiments of the present invention, a computer-readable medium for storing a set of instructions for providing visual display security on a general-purpose computer, the general-purpose computer being capable of running an operating system and an application program, the operating system and application program presenting a user interface in the form of display windows, the instructions comprising instructions for causing the computer to perform the following steps of displaying a window having a default display characteristic, and altering the default display characteristic to a modified display characteristic using a computer security program operating on the general purpose computer. The method includes matching a pattern to the modified display characteristic, and overlaying the pattern on the display window, the pattern rendering the display window unreadable, the pattern overlayed on the display window being capable of being filtered with an optical filter matched to the modified display characteristic so that the display window becomes readable when viewed through the optical filter.

### BRIEF DESCRIPTION OF THE DRAWINGS

FIG. 1 is a screen display in accordance with a computer security program capable of performing the present invention.

FIG. 2 is a user selection window for choosing certain attributes of the computer security program according to one aspect of the present invention.

FIG. 3 is an example of a display window according to one embodiment of the present invention.

FIG. 4 is a second user selection window for choosing attributes of the computer security program according to one aspect of the present invention.

FIG. 5 is one example of a display window modified according to one aspect of the present invention.

FIG. 6 is a second screen display of a display window according to yet another aspect of the present invention.

FIG. 7 is a second example of a display window according to another aspect of the present invention.

FIG. 8 is yet another example of a display window according to one aspect of the present invention.

FIG. 9 illustrates examples of an optical filter according to one aspect of the present invention.

### DETAILED DESCRIPTION OF A PREFERRED EMBODIMENT

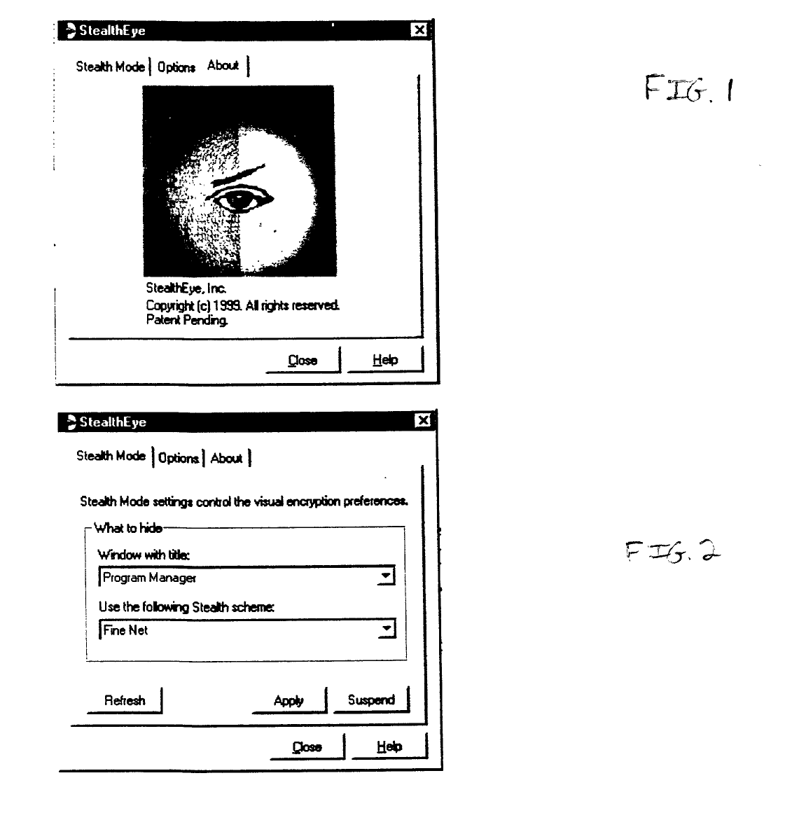

Referring to FIG. 1, in accordance with certain preferred embodiments, when the software starts it searches for all the software applications that are currently running. The software then compiles an internal list of all of the currently running applications that have a or Graphical User Interface (GUI). The computer security program of the present invention will present the user with applications that have a GUI that the user may want to “hide.” The software then displays this list of all of the currently running, visible applications to the user. The user is provided with a list of all of the application titles to make it easy for him to identify and select a particular application that he wants to “hide.”

Referring to FIGS. 2 and 3, when the user selects an application that he wants to “hide,” the computer security program obtains a handle to that applications Window object. All applications that have a GUI have a Window Handle, the Window Handle being one example of a programming interface to the display window in the computing environment. With this Window Handle, the computer security program can manipulate the application's GUI and intercept any and all events that are generated by that program. Additionally, the complete security program can obtain a handle to the user's entire computer display, or the “Desktop” in the parlance of Windows, thereby “hiding” the entire contents being displayed by his computer monitor instead of just “hiding” a single program application display window.

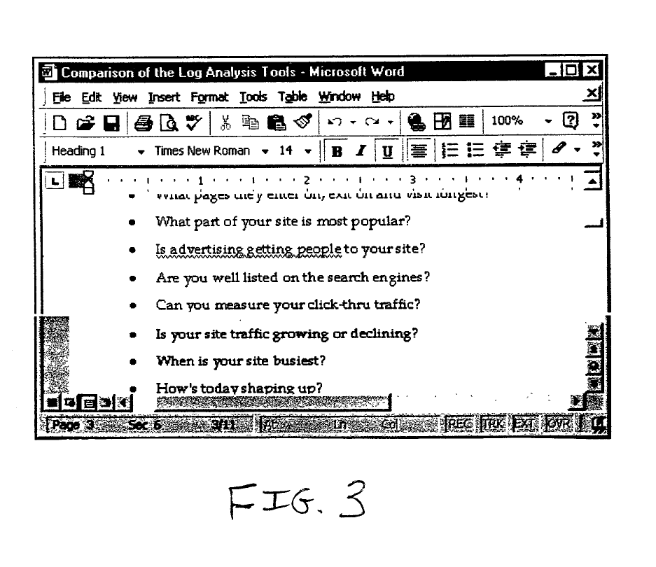

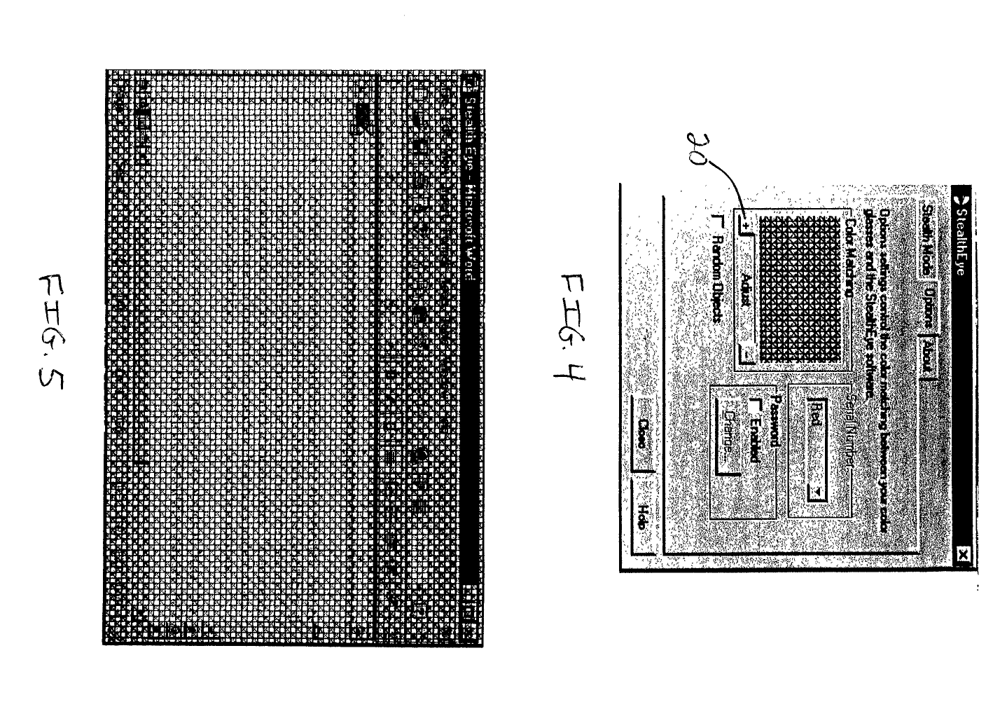

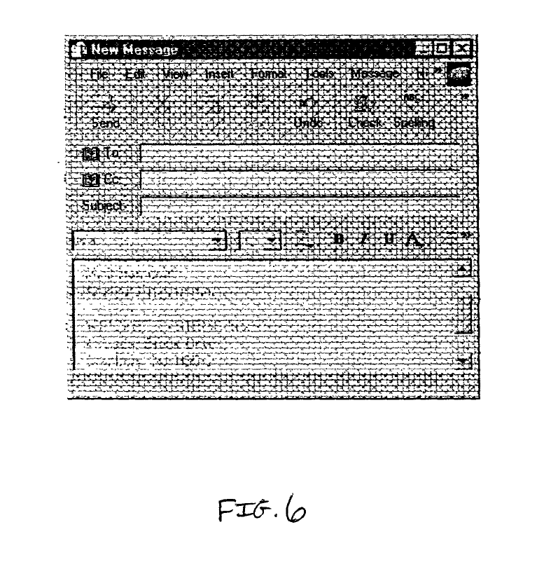

Referring to FIG. 4, once the user selects a particular application to “hide”, he has the ability to select one of many different visually obscuring patterns. Depending on the application, one pattern may provide superior visual security over other patterns. Several patterns envisioned include colorized matrix patterns, e.g., patterns of a given color and constructed of a repetitive densely-packed geometric pixel arrangement that renders unreadable the window over which the pattern is drawn. Examples of the colorized patterns are illustrated in FIGS. 5, 6 and 7. Other geometric window transformations such as “stretching,” “burning” or a random stereo dot gram may also be used to obscure the display window. FIG. 2 shows an exemplary user selection box in the computer security system for selecting an application to hide and the pattern to be used. As a result, one or more default characteristics of the display window are altered to render the display window unreadable without using an optical filter as will be described in more detail below.

Once the application and obscuring pattern are selected, the user then selects the color of the pattern that best matches the color of the optical filter. The optical filter, which is used to view the obscured application display window, may be as simple as a piece of colorized cellophane or as complex as a pair of optical glasses as illustrated in FIG. 9. In any case, the optical properties of the optical filter are chosen to match the obscuring method used to render the application display window unreadable. In the case where the optical transfer is “stretching” or stereo dot generation, the optical filter provides an inverse optical transform to “undo” the optical effect. When the obscuring pattern is an overlaid colorized matrix, the optical filter is selected to match the color of the pattern so as to permit that wavelength of reflected light to be filtered by the glasses, thereby permitting the underlying text or image to be viewed. In many instances, it is also desirable to modify the underlying text or image graphics in the application display window in addition to overlying the colorized pattern so as to improve the readability of the text or image graphics with the optical filter.

Currently, monitors from different manufactures display different color characteristics. To address this issue, the computer security program of the present invention allows the user to fine tune the selected pattern and/or color. As a result, the user may match the pattern color exactly with the optical filter being utilized. An example of the color matching turning is shown with the +/− adjustment bar 20 in the color matching portion of FIG. 4.

Once the user has selected the application he wants to “hide,” the selected colorized pattern, and has fine-tuned the color to match the optical filter, the user may activate the computer security program.

When the colorized pattern is applied to a running and visible application, it may first change the color of the default font used by that window to improve font readability prior to applying the colorized pattern. The color of the fonts is changed to match the colorized pattern's color.

In a preferred embodiment of the present invention, the computer security program uses color filter technology to “hide” text and images displayed on a computer screen. In addition to color filtering, the computer security program can use image filters and distortion lenses to distort image patterns within the display and reassemble, or inverse transform, the images using the optical filter. An example of such technique is a random dot stereo gram that can be produced by the computer security program.

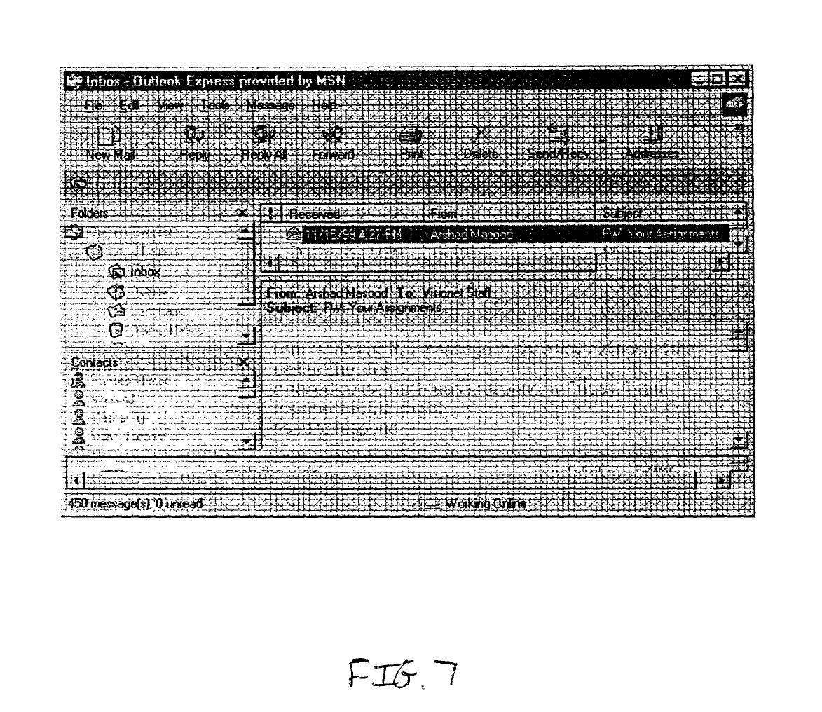

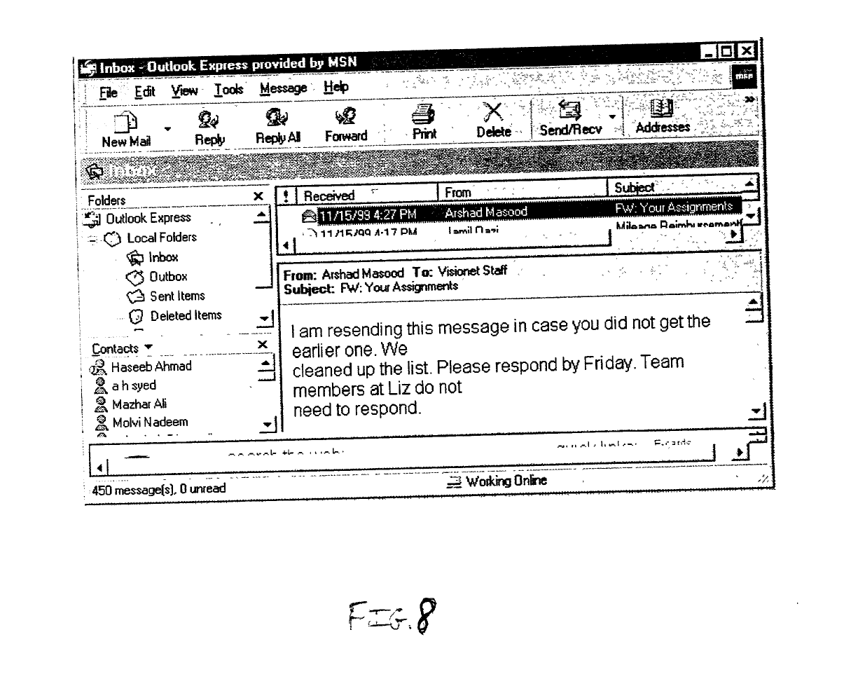

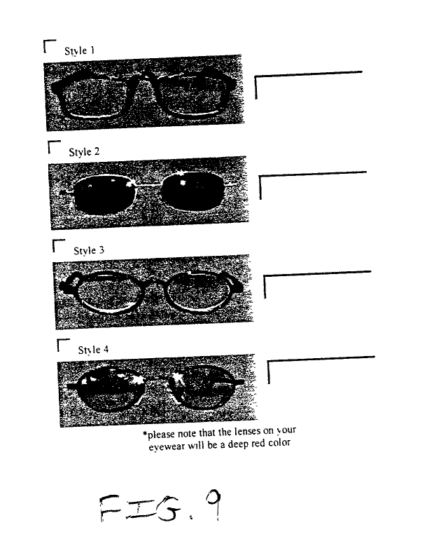

Color filtering techniques may be widely used in applications that mask different colors. If the optical filter uses a color, for example, RED (580 nm-630 nm), and provides different patterns on the computer screen using the selected color, then to the visible eye, the content of the computer screen is unreadable as it shows a jumble of different colors and patterns. FIG. 7 shows a screen that is unreadable to the human eye because the screen has been color filtered. FIG. 8 shows how the screen appears to an individual using optical glasses that filter the screen so that the user may read the text in the clear. However, through the use of sharp cutoff color filters, say with a threshold of 580 nm, the original color used to “hide” or jumble the screen is removed from the human eye and thus the reader can make sense of the computer screen content.

Once the application is running, many user-generated events can attempt to disrupt the “hiding” technology. Events such as window repositioning and resizing (including minimizing and maximizing the application), keyboard events (such as typing), and mouse events (such as button clicks, and menu clicks) can dynamically change the GUI properties of the application. To address this issue, the computer security program detects and intercepts all of the events generated by this application and re-applies the obscuring pattern or color dynamically.

An additional security feature that the computer security software may offer is a password protection option. When this option is enabled, a password is necessary to deactivate the security mode, and therefore only authorized users can gain access to the “hidden” application.

When an authorized user disables the computer security software from an application, or from the entire desktop as the case may be, the font colors are restored to their original color and the colorized pattern is removed from the GUI of the application. An example of the unmodified display window is shown in FIG. 7. This returns the application to its pre-security mode state and therefore becomes visible to anyone without the need of the optical filter.

Although the present invention has been described with reference to particular embodiments, it is to be understood that the embodiments are merely illustrative of the principles and applications of the present invention. It is therefore to be understood that numerous modifications may be made to the above-described embodiments and that other arrangements may be devised without departing from the spirit and scope of the present invention as defined by the claims.

1. A system for providing visual display security on a general-purpose computer, said general-purpose computer capable of running an operating system and an application program, said operating system and application program presenting a user interface in the form of display windows, said system comprising:
a display window having a default display characteristic;
a computer security program operating on said general purpose computer, said computer security program altering said default display characteristic to a modified display characteristic, said modified display characteristic rendering said display window unreadable, and
an optical filter matched to said modified display characteristic such that said display window becomes readable when viewed through said optical filter.

2. The visual display security system of claim 1 wherein said modified display characteristic comprises a random dot stereo gram.

3. The visual display security system of claim 1 wherein said modified display characteristic comprises a stretching algorithm applied to said display window.

4. The visual display security system of claim 1 wherein said modified display characteristic comprises a blurring algorithm applied to said display window.

5. The visual display security system of claim 1 wherein said modified display characteristic comprises an optical pattern superimposed on said display window.

6. The visual display security system of claim 5 wherein said optical pattern further comprises a color matched to said optical filter.

7. The visual display security system of claim 1 wherein said modified display characteristic comprises a displayed image shape.

8. The visual display security system of claim 1 wherein said optical filter is a pair of glasses.

9. The visual display security system of claim 1 wherein said optical filter is a screen placed on said display window.

10. The visual display security system of claim 1 further comprising a password protection module for disabling and enabling said visual display security system.

11. The visual display security system of claim 1 further comprising a tuner for matching said modified display characteristic to said optical filter.

12. A system for providing visual display security on a general-purpose computer, said general-purpose computer capable of running an operating system and an application program, said operating system and application program presenting a user interface in the form of display windows, said system comprising:
a display window having a default display characteristic;
a computer security program operating on said general purpose computer, said computer security program altering said default display characteristic to a modified display characteristic, said computer security program overlaying a pattern on said display window, said pattern operatively associated with said modified display characteristic, said pattern rendering said display window unreadable, and
an optical filter operatively associated with said pattern such that said display window becomes readable when viewed through said optical filter.

13. The visual display security system of claim 12 wherein said default display characteristic is a default font color, said modified display characteristic is a modified font color, said pattern is a colorized pattern and said optical filter is a color filter, said modified font color being matched to said optical filter so as to permit the modified font color to be visible as perceived though said optical filter when said colorized a pattern overlayed on said display window.

14. The visual display security system of claim 12 wherein said optical filter is a pair of glasses.

15. The visual display security system of claim 12 wherein said optical filter is a screen placed on said display window.

16. The visual display security system of claim 12 further comprising a password protection module for disabling and enabling said visual display security system.

17. The visual display security system of claim 12 further comprising a tuner for matching said pattern to said optical filter.

18. A method for providing visual display security on a general-purpose computer, said general-purpose computer capable of running an operating system and an application program, said operating system and application program presenting a user interface in the form of display windows, said method comprising:
displaying a window having a default display characteristic;
altering said default display characteristic to a modified display characteristic using a computer security program operating on said general purpose computer, said alteration rendering said display window unreadable, and
filtering said display window with an optical filter matched to said modified display characteristic such that said display window becomes readable when viewed through said optical filter.

19. The method for providing visual display security of claim 18 wherein said step of altering further comprises:
obtaining an application program handle;
intercepting events generated by said program handle; and
reapplying continuously said modified display characteristic in response to said intercepted events.

20. The method for providing visual display security of claim 18 further comprising tuning said modified display characteristic to match said optical filter.

21. The method for providing visual display security of claims 18 further comprising:
creating a list including a plurality of active display windows; and
selecting one of said plurality of active display windows in which to alter said default display characteristic.

22. A method for providing visual display security on a general-purpose computer, said general-purpose computer capable of running an operating system and an application program, said operating system and application program presenting a user interface in the form of display windows, said method comprising:
displaying a window having a default display characteristic;
altering said default display characteristic to a modified display characteristic using a computer security program operating on said general purpose computer;
matching a pattern to said modified display characteristic;
overlaying said pattern on said display window, said pattern rendering said display window unreadable, and
filtering said display window with an optical filter matched to said pattern such that said display window becomes readable when viewed through said optical filter.

23. The method for providing visual display security of claim 22 wherein said step of altering further comprises:
obtaining an application program handle;
intercepting events generated by said program handle; and
reapplying continuously said modified display characteristic and said pattern in response to said intercepted events.

24. The method for providing visual display security of claim 22 further comprising tuning said pattern to match said optical filter.

25. The method for providing visual display security of claim 22 further comprising:
creating a list including a plurality of active display windows; and
selecting one of said plurality of active display windows for which to overlay said pattern.

26. A computer-readable medium for storing a set of instructions for providing visual display security on a general-purpose computer, said general-purpose computer capable of running an operating system and an application program, said operating system and application program presenting a user interface in the form of display windows, said instructions comprising instructions for causing said computer to:
display a window having a default display characteristic; and
alter said default display characteristic to a modified display characteristic using a computer security program operating on said general purpose computer, said alteration rendering said display window unreadable, said modified display characteristic in said display window capable of being filtered with an optical filter matched to said modified display characteristic such that said display window becomes readable when viewed through said optical filter.

27. A computer-readable medium for storing a set of instructions for providing visual display security on a general-purpose computer, said general-purpose computer capable of running an operating system and an application program, said operating system and application program presenting a user interface in the form of display windows, said instructions comprising instructions for causing said computer to:
displaying a window having a default display characteristic;
altering said default display characteristic to a modified display characteristic using a computer security program operating on said general purpose computer;
matching a pattern to said modified display characteristic; and
overlaying said pattern on said display window, said pattern rendering said display window unreadable, said pattern overlaid on said display window capable of being filtered with an optical filter matched to said modified display characteristic such that said display window becomes readable when viewed through said optical filter.
